(19) United States
(12) Patent Application Publication
(10) Pub. No.: US 2005/0091606 A1
(43) Pub. Date: Apr. 28, 2005

(54) Systems and methods for displaying wrapped lists

(76) Inventor: Volker Sauermann, Heidelberg (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/691,534

(22) Filed: Oct. 24, 2003

(51) Int. Cl. G06F 3/00; G06F 17/24

(52) U.S. Cl. 715/788; 715/517; 715/518; 715/519; 715/520; 715/521; 715/779; 715/781; 715/783; 715/792; 715/790; 715/801

(57) ABSTRACT

Systems and methods are disclosed for providing user-friendly displays of data, particularly data displayed in a list. If a list item or other data is too wide to be displayed entirely in the horizontal space available in a single display area, then the data may be wrapped into an additional, separate display area. In one embodiment, wide list entries and other data are displayed by wrapping onto two or more display areas, making all the data visible to the user on the screen at the same time.

### BACKGROUND OF THE INVENTION

I. Field of the Invention

The present invention relates to user-friendly interfaces for the display of data and, more particularly, to the user-friendly display of large data sets, such as wide or multi-column data.

II. Background of the Invention

In many computer applications, data is displayed to a user in the form of a list. A displayed list typically contains several lines or rows, each line representing an item in the list, and each line may contain several distinct pieces of data arranged in columns. For some application programs, such as database programs and search engines, the lines in a displayed list may be records from a table stored in a database, where each column represents an attribute of an item in the list.

A problem arises if a user wishes to display more data than a computer screen can handle in the area available. For example, a list may have more lines than can be displayed in the available vertical display area, or a list may have more columns than can be displayed in the available horizontal display area.

One conventional solution to this problem is to reduce the size of the text displayed on the screen, thus allowing more lines to fit into the available vertical display area or more columns to fit into the available horizontal area. This solution, however, is not user friendly because smaller text is more difficult for a user to read.

Another conventional solution offers a vertical scroll bar to the user for scrolling up and down the list of items and/or a horizontal scroll bar for scrolling left and right across the columns for the displayed items. This solution, however, also has disadvantages. For example, all the columns are not displayed together at the same time, so only a portion of the columns for each displayed row in the list are visible to the user. As a result, the user must scroll the list horizontally to display columns that were formerly hidden, thus hiding columns that were formerly displayed. This makes it difficult for the user to locate data of interest and to coherently consider data from columns that cannot be displayed simultaneously in the available horizontal space.

By way of example, FIG. 1 shows a conventional scroll bar list display 100. In the example of FIG. 1, the list display 100 displays information related to the queue server administration of a text retrieval and search engine that is running in a distributed environment. Any given queue server in the system may maintain several document queues. As FIG. 1 shows, queue server list display 100 represents each queue in the system as a row on the list display. Each row starts with a “Queue Name” 110 in the first column. The conventional list display illustrated shows information about each queue. For example, state flags and configuration parameters are shown in separate columns, such as the “Queue State” column 120, the “Time Stamp” column 130, and the “Return Code” column 140. If there are too many columns of information to fit within the width boundary of the screen (as represented in the example of FIG. 1), a horizontal scroll bar 150 allows a user to move the column view right or left to see data in columns that are offscreen. The shaded and unshaded portions of the horizontal scrollbar 150 shown in FIG. 1 indicate that only about two thirds of the complete list width is visible to the user at any one time. This makes it difficult and tiresome for a user to view and control all the queue parameters (list columns) of a document queue at the same time because he or she must keep scrolling back and forth across the list columns, moving some information offscreen to make room for columns that come onscreen. Horizontal scrolling is especially tiresome when the column information automatically updates or is refreshed or changed by clicking an action button 160 (such as refresh, sort, filter, etc.), because the user must expend considerable effort to see and compare the new values that appear in all the columns.

### SUMMARY OF THE INVENTION

Consistent with embodiments of the invention, systems and methods are provided for the user-friendly display of lists. As disclosed herein, the lists may include items or other data that are too large or wide to be displayed entirely in the space available, i.e., within the boundaries of the width, in the available display area, such as a single window. To provide a user-friendly display, wide list entries and other data may be displayed by wrapping onto two or more display areas, making all the data for a row of the list visible to the user on the screen at the same time.

In accordance with one embodiment, a method for displaying data using a display area having a width boundary consistent with this invention may comprise: determining that data for a list item cannot be displayed within the width boundary; creating a first display area and a second display area based on the determination that data for a list item cannot be displayed within the width boundary; splitting the data for the list item into a first portion and a second portion, such that the first portion will fit into the first display area; displaying the first portion of the data for the list item in the first display area; and displaying the second portion of the data for the list item wrapped into the second display area.

According to another embodiment, a system for displaying data using a display area having a width boundary consistent with this invention may comprise: means for determining that data for a list item cannot be displayed within the width boundary; means for creating a first display area and a second display area based on the determination that data for a list item cannot be displayed within the width boundary; means for splitting the data for the list item into a first portion and a second portion, such that the first portion will fit into the first display area; means for displaying the first portion of the data for the list item in the first display area; and means for displaying the second portion of the data for the list item wrapped into the second display area.

In accordance with yet another embodiment, a computer program product for displaying data using a display area having a width boundary consistent with this invention may comprise code for causing a processor to perform the steps of: determining that data for a list item cannot be displayed within the width boundary; creating a first display area and a second display area based on the determination that data for a list item cannot be displayed within the width boundary; splitting the data for the list item into a first portion and a second portion, such that the first portion will fit into the first display area; displaying the first portion of the data for the list item in the first display area; and displaying the second portion of the data for the list item wrapped into the second display area. According to still another embodiment, a method for displaying data consistent with the invention may comprise: creating a first display area and a second display area when the data for a list item cannot be displayed within the width of a single display area; displaying a first portion of the data for the list item in the first display area; and displaying the second portion of the data for the list item wrapped into the second display area, wherein the first portion and second portion comprise all of the data for the list item.

It is to be understood that both the foregoing general description and the following detailed description are exemplary and explanatory only, and should not be considered restrictive of the scope of the invention, as described and claimed. Further features and/or variations may be provided in addition to those set forth herein. For example, embodiments consistent with the invention may be directed to various combinations and sub-combinations of the features described in detail herein.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a conventional example of information displayed in a typical list format;

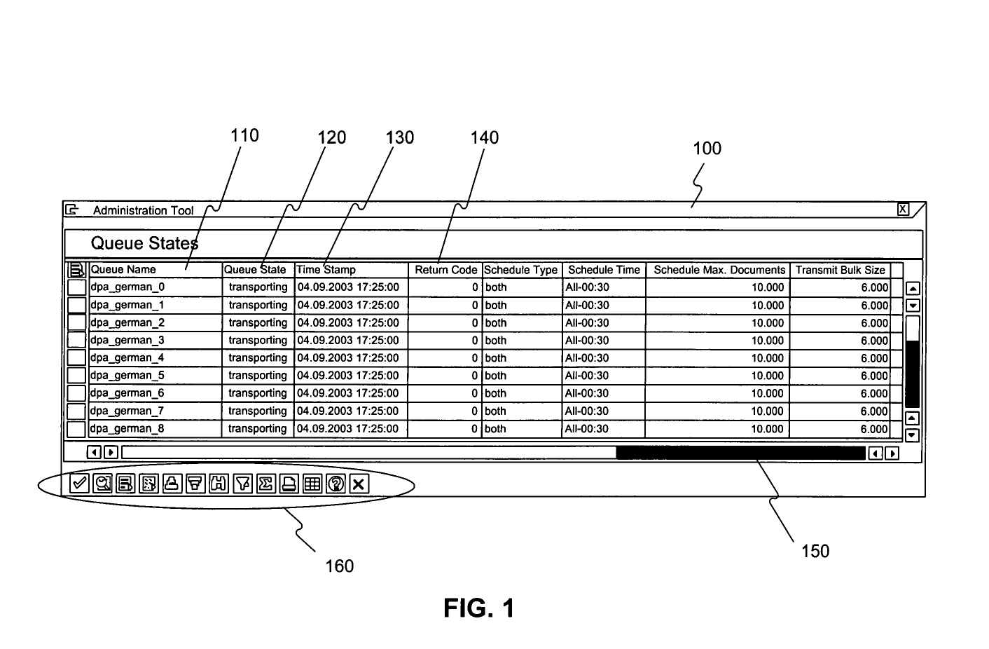

FIG. 2 is an example of a display consistent with an embodiment of the invention;

FIG. 3 is another example of a display consistent with an embodiment of the invention;

FIG. 4 is a flow chart illustrating an exemplary process for generating a display of wrapped data, consistent with an embodiment of the present invention;

FIG. 5 shows another exemplary embodiment that displays data from two different data sources in a multiple-display-area wrapped display; and

FIG. 6 illustrates an exemplary computing system with which embodiments of the invention may be implemented.

### DETAILED DESCRIPTION

The following paragraphs describe implementations consistent with embodiments of the invention. These implementations are merely examples and are not intended to limit the scope of the claims. Wherever convenient, the same reference numbers will be used throughout the drawings to refer to the same or like parts.

Systems and methods consistent with the present invention display lists that are too large or wide to be displayed within the horizontal width boundaries of in a single display area, such as a window display. For example, to provide a user-friendly display of lists that are horizontally larger than the available display area, the list's rows are wrapped into an additional, separate window on the display. Thus, all the information for a list item is visible to the user at the same time in multiple windows or screen areas.

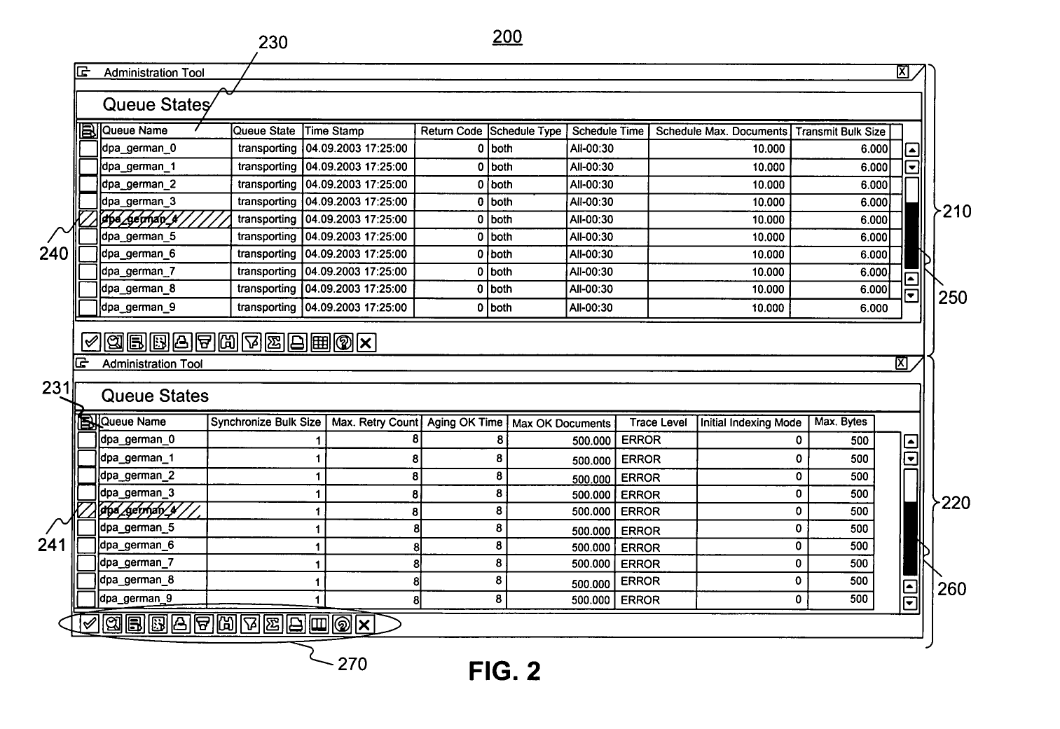

FIG. 2 shows an example of a display 200 consistent with an embodiment of the present invention. Display 200 displays two display areas 210 and 220 at the same time. In one embodiment consistent with the invention, the two display areas 210 and 220 are implemented as windows. For wider lists having more data columns, more than two display areas could be used. In the embodiment shown, the display areas are positioned close together for easy comprehension, one below the other. Further, display area 210 may have the same height and approximately the same width as display area 220. In another embodiment consistent with the invention, the two display areas do not have the same dimensions; for example, the second display area may have a smaller width to accommodate fewer columns, which are sufficient to present all the data associated with the list item.

As shown in FIG. 2, the list in the upper display area 210 wraps into the lower display area 220. That is, the rows of data for each item in the list displayed in display area 210 continue in the corresponding rows of the list displayed in display area 220. For example, row 240 for queue name “dpa_german_{—}4” in upper display area 210 wraps to corresponding row 241 labeled “dpa_german_{—}4” in lower display area 220. In this embodiment, the display aids the user in comprehending which rows in the two display areas correspond to each other by keeping the first column “Queue Name” 230 in display area 210 the same as the first column “Queue Name” 231 in display area 220. This wrapped display allows a user to see all the columns of information for each queue in the list on the display screen at the same time. One of ordinary skill will realize that other display features consistent with the invention may be used as an aid to a user in comprehending which rows in the two display areas correspond to each other or wrap, such as color coding or numbering corresponding wrapped rows. One of ordinary skill will also recognize that embodiments that use three or more display areas to display wrapped data are also consistent with the present invention, and that a list may contain one or more items. Further, one of ordinary skill will recognize that the present invention is not limited to data organized and displayed in column format. The principles of the invention apply to any data that is too wide when displayed to fit in a single row of the display area.

In one embodiment consistent with the invention, events, such as selecting a row, selecting a column, sorting, refreshing, etc., in either of the two display areas are executed synchronously in both display areas using conventional synchronous event handling techniques. For example, a user event such as the movement of vertical scroll bar 260 in display area 220 causes the identical vertical scrolling (same direction, same distance) of both the list displayed in display area 220 and the list displayed in display area 210, as well as appropriate movement of both scroll bar indicators 250 and 260. A further example, as shown in FIG. 2 by cross hatching, includes a user highlighting a row 240 in the upper display area 210, and the corresponding wrapped line 241 in the lower display area 220 is automatically highlighted also. Yet a further example includes a user activating one of the action buttons 270 to close display area 220 and the other display area 210 also closes. In another embodiment, the display areas are not automatically synchronized for all events and the user must manually update each display area separately.

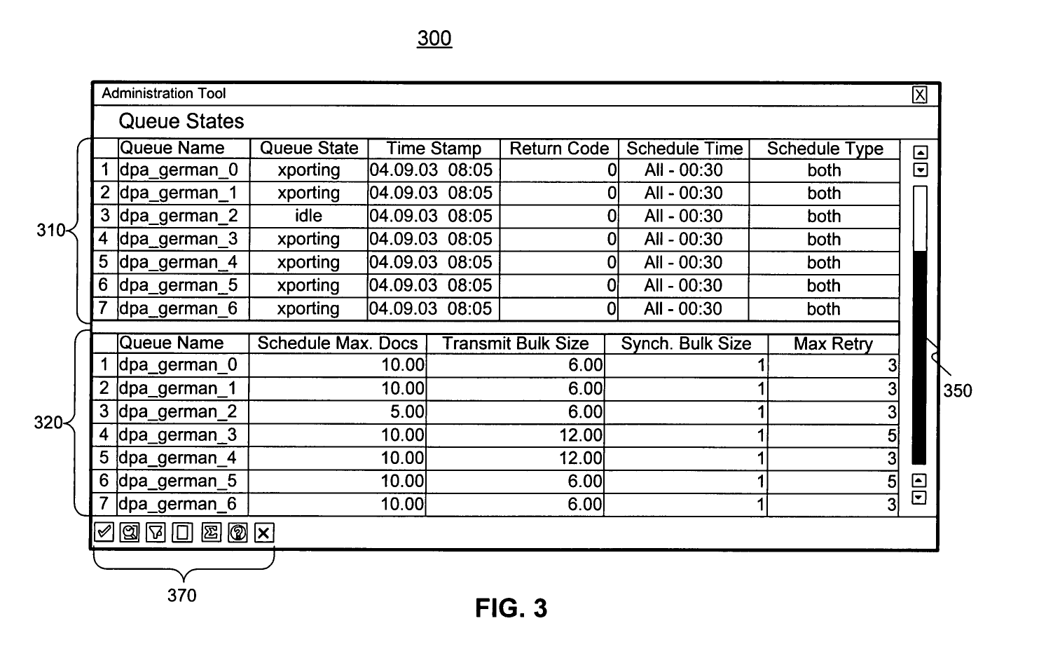

FIG. 3 illustrates another embodiment of a display consistent with the present invention, in which the wrapped list display 300 is a single display area comprising two subareas or split panes, shown as subarea 310 and subarea 320. As shown, this embodiment displays the subareas one below the other. The upper pane 310 displays as many columns from the list as will fit into the available horizontal display space and the lower pane 320 displays the remaining wrapped columns corresponding to the list items in the upper pane 310. In this embodiment, the whole display display area 300 has only one row of action buttons 370 and one vertical scroll bar 350. If the user activates one of the action buttons 370 or the scroll bar 350, the triggered functionality affects both split panes 310 and 320. The scroll bar 350 scrolls the lists in both panes simultaneously in the same direction and by the same amount.

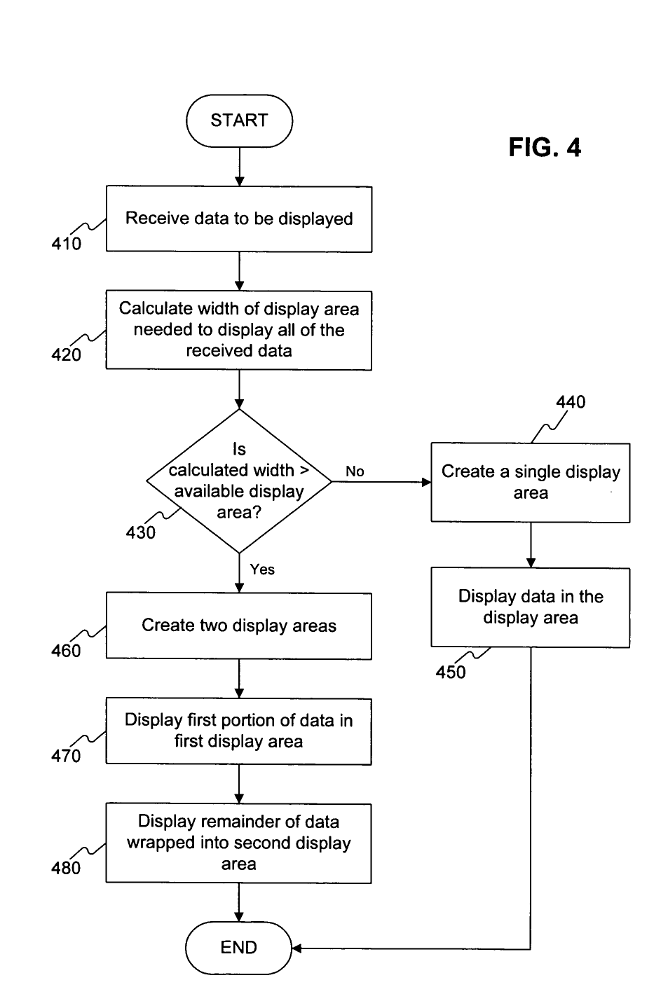

FIG. 4 is a flow chart illustrating an exemplary process for generating a display of wrapped data, consistent with an embodiment of the present invention. The embodiment of FIG. 4 may be carried out by a computer system for generating a display for showing data in a wrapped list format consistent with the invention, such as the displays shown in FIGS. 2 and 3. To start, the process receives the data that is to be displayed (step 410). Next, the process calculates the amount of horizontal display area that will be needed to display the received data (step 420). In one embodiment consistent with the invention, this calculation is based on the current display settings, such as font size and screen resolution, of the computer system running the process and on the current width boundary of the display area that will be used to display the data. In this embodiment, the default display area width is the maximum width display area that will fit on the display screen. In another embodiment consistent with the invention, the process calculates the total display width using preset or user-specified default display settings and/or a default horizontal display boundary value.

The computer next compares the calculated display width needed to display the received data to the available horizontal display area (step 430). If the needed display width is less than or equal to the available display width (step 430, no), then the process creates a single display area, such as a window, to display the data (step 440) and displays the data in the created display area (step 450). Because it all fits on a single line, a user can see all the data for each displayed item in the list at the same time.

If, on the other hand, the needed display width is greater than the available display width (i.e., the data cannot all fit on a single line) (step 430, yes), then the process creates two display areas, such as two windows or a split-pane window (step 460). The computer splits the data into two portions and displays the first portion of the data, for example, as much of the data as will fit in the available horizontal display area, in the first display area created (step 470) and displays the second portion of the data, for example, the remainder of the data, in the second display area created (step 480). Thus, a user can see all the data for a displayed list item in the two display areas, with the excess data for an item that will not fit in the first display area displayed by wrapping into the second display area. Of course, if a display area already existed when the process started, the computer could use the existing display area to display the first portion of the data, and accordingly create only the second display area needed to display the second portion of the data.

The present invention is not limited to two display areas as described in the embodiment of FIG. 4. One of ordinary skill in the art will recognize that the process shown in FIG. 4 may be modified to determine a need for, and create, more than two display areas so that the list item display may wrap from a second to a third display area, etc. in order to display all the data for a list item. One of ordinary skill in the art will also recognize that FIG. 4 is not the only possible implementation consistent with the present invention, as the process shown could have steps added, deleted, or modified and remain consistent with the invention. For example, step 460 could be modified to create three or more display areas as necessary to completely display the wrapped list data. For another example, steps could be added to allow a user to change the width of the display area or display areas displaying the data or the width of each individual column, in which case steps could also be added to the process to calculate the number of display areas needed to wrap and display the data based on the user-selected display area or column width, and steps could be added to create any additional needed display areas or remove any unneeded display areas. Also, as mentioned above, the process could be modified to create a single display area employing split panes, as shown in FIG. 3, without departing from the principles of the invention.

One of ordinary skill in the art will further recognize that the process shown in FIG. 4 can be modified within the principles of the invention to allow a user to choose the exact data columns he or she wishes to display, for example by selecting a subset of all the available data that make up a row of the list. In one example of this embodiment, the process allows a user to delete selected columns from the display areas. In response, the process calculates the total number of display areas needed to display the remaining columns of data and splits and displays the list data (taking into account the data columns deleted by the user) using the newly calculated number of display areas and wrapping as needed.

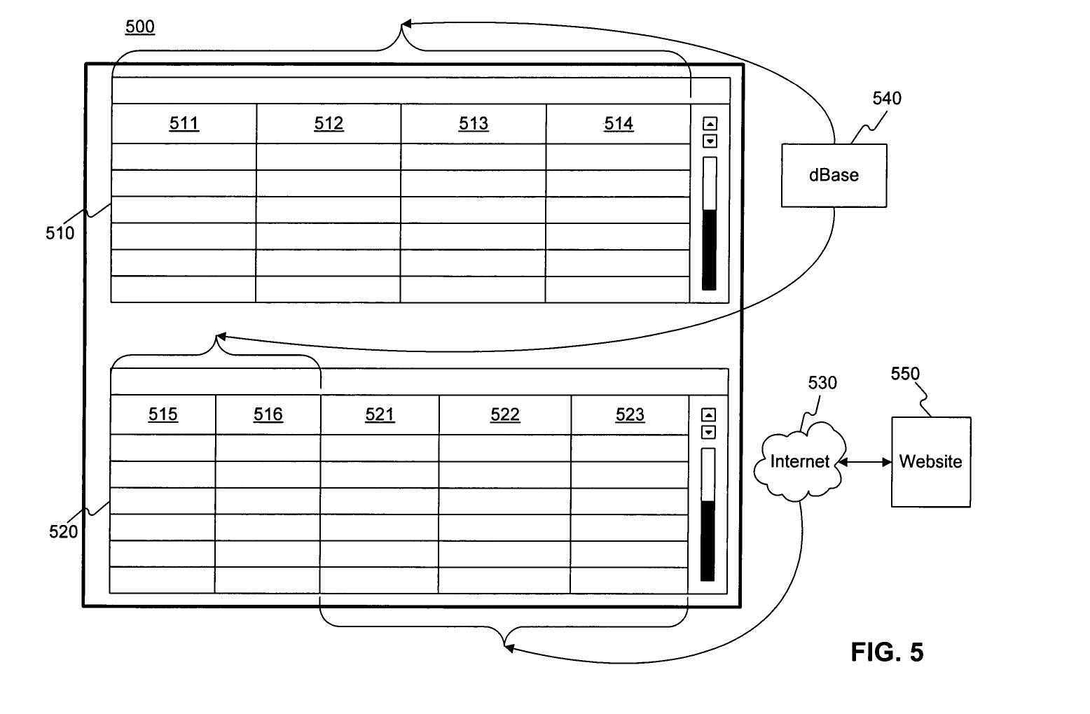

FIG. 5 shows another exemplary embodiment that displays data from two different data sources in a multiple-display-area wrapped display. In this embodiment, two or more data sources, such as database 540 and website 550, are logically linked together or otherwise associated for purposes of displaying their data as a list of items on a display 500. As shown, the system displays the data from records in database 540 in columns 511, 512, 513, and 514 in display area 510, wrapping into columns 515 and 516 in display area 520. The system also displays the data from website 550, which is received via the Internet 530, as a wrapped continuation of the database 540 data items in columns 521, 522, and 523. In this embodiment, a user can see all the data associated with the items in the list, including data from a secondary data source (such as website 550), all at once on a single display. One of ordinary skill will realize that the embodiment shown in FIG. 5 may be expanded to include more than two data sources and to use more than two wrapped display areas, for example using a third display area to display additional data from website 550, without departing from the principles of the present invention.

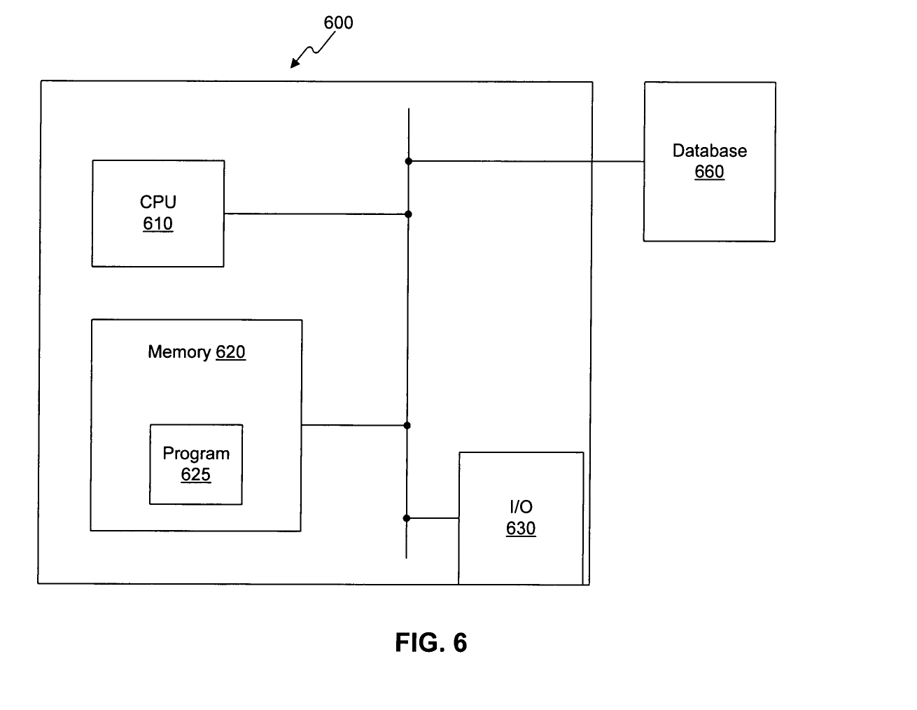

FIG. 6 illustrates an exemplary computing system 600 that can be used to implement embodiments of the invention. The components and arrangement, however, are not critical to the present invention.

System 600 includes a number of components, such as a central processing unit (CPU) 610, a memory 620, an input/output (I/O) device(s) 630, and a database 660 that can be implemented in various ways. For example, an integrated platform (such as a workstation, personal computer, laptop, etc.) may comprise CPU 610, memory 620 and I/O devices 630. In such a configuration, components 610, 620, and 630 may connect through a local bus interface and access to database 660 (implemented as a separate database system) may be facilitated through a direct communication link, a local area network (LAN), a wide area network (WAN) and/or other suitable connections.

CPU 610 may be one or more known processing devices, such as a microprocessor from the Pentium family manufactured by Intel™. Memory 620 may be one or more storage devices configured to store information used by CPU 610 to perform certain functions related to embodiments of the present invention. Memory 620 may be a magnetic, semiconductor, tape, optical, or other type of storage device. In one embodiment, memory 620 includes one or more programs 625 that, when executed by CPU 610, perform various processes consistent with the present invention. For example, memory 620 may include a queue administration program 625 that, when executed by CPU 610, displays the queue states in a list format and wraps list items that are too long to fit into one row of a display area (such as a window or pane) into a second display area. Memory 620 may also include other programs that perform other functions consistent with embodiments of the invention.

Methods, systems, and articles of manufacture consistent with the present invention are not limited to programs configured to perform dedicated tasks. For example, memory 620 may be configured with a program 625 that performs several functions when executed by CPU 610. That is, memory 620 may include a program for searching database 660 and for displaying overlong search results by splitting the display area into two parts, subareas, or panes and wrapping data into the second pane. Alternatively, CPU 610 may execute one or more programs located remotely from system 600. For example, system 600 may access one or more remote programs that, when executed, perform functions related to embodiments of the present invention.

Memory 620 may be also be configured with an operating system (not shown) that performs several functions well known in the art when executed by CPU 610. By way of example, the operating system may be Microsoft Windows™, Unix™, Linux™, an Apple Computers operating system, Personal Digital Assistant operating system such as Microsoft CE™, or other operating system. The choice of operating system, and even to the use of an operating system, is not critical to the invention.

I/O device(s) 630 may comprise one or more input/output devices that allow data to be received and/or transmitted by system 600. For example, I/O device 630 may include one or more input devices, such as a keyboard, touch screen, mouse, and the like, that enable data to be input from a user. Further, I/O device 630 may include one or more output devices, such as a display screen, printer, speaker devices, and the like, that enable data to be output or presented to a user. The configuration and number of input and/or output devices incorporated in I/O device 630 are not critical to the invention.

Database 660 may comprise one or more databases that store information and are accessed and managed through system 600. By way of example, database 660 may be an Oracle™ database, a Sybase™ database, or other relational database. Systems and methods of the present invention, however, are not limited to separate databases or even to the use of a database. Although some embodiments described above display rows and columns retrieved from databases, those skilled in the art will appreciate that embodiments of the present invention can display data from practically any source, such as the internet and other organized collections of data or memory systems.

One of ordinary skill in the art will also recognize that the embodiments described and suggested above can be implemented using conventional equipment and programming techniques.

Other embodiments of the invention will be apparent to those skilled in the art from consideration of the specification and practice of the invention disclosed herein. Therefore, the specification and examples are exemplary only. The following claims indicate the true scope of the invention.

1. A method for displaying data using a display area having a width boundary comprising:
determining that data for a list item cannot be displayed within the width boundary;
creating a first display area and a second display area based on the determination that data for a list item cannot be displayed within the width boundary;
splitting the data for the list item into a first portion and a second portion, such that the first portion will fit into the first display area;
displaying the first portion of the data for the list item in the first display area; and
displaying the second portion of the data for the list item wrapped into the second display area.

2. The method for displaying data of claim 1, wherein the first display area is one of a group comprising: a first window and a first pane; and
wherein the second display area is one of a group comprising: a second window and a second pane.

3. The method for displaying data of claim 1, wherein the data for a list item comes from more than one data source.

4. The method for displaying data of claim 1, wherein displaying the second portion of the data further comprises:
displaying at least one column of data from the first portion in the second display area.

5. The method for displaying data of claim 1, wherein displaying the second portion of the data further comprises:
displaying an aid to comprehend whether a row of data in the second display area corresponds to a row of data in the first display area.

6. The method for displaying data of claim 5, wherein the aid is one of a group comprising: a number and a color.

7. The method for displaying data of claim 1, wherein the first display area and the second display area are both controlled by a single scroll bar.

8. The method for displaying data of claim 1, further comprising:
handling an event associated with the first display area such that the event synchronously affects the second display area.

9. A system for displaying data using a display area having a width boundary comprising:
means for determining that data for a list item cannot be displayed within the width boundary;
means for creating a first display area and a second display area based on the determination that data for a list item cannot be displayed within the width boundary;
means for splitting the data for the list item into a first portion and a second portion, such that the first portion will fit into the first display area;
means for displaying the first portion of the data for the list item in the first display area; and
means for displaying the second portion of the data for the list item wrapped into the second display area.

10. The system for displaying data of claim 9, wherein the first display area is one of a group comprising: a first window and a first pane; and
wherein the second display area is one of a group comprising: a second window and a second pane.

11. The system for displaying data of claim 9, wherein the data for a list item comes from more than one data source.

12. The system for displaying data of claim 9, wherein the means for displaying the second portion of the data further comprises:
means for displaying at least one column of data from the first portion in the second display area.

13. The system for displaying data of claim 9, wherein the means for displaying the second portion of the data further comprises:
means for displaying an aid to comprehend whether a row of data in the second display area corresponds to a row of data in the first display area.

14. The system for displaying data of claim 13, wherein the aid is one of a group comprising: a number and a color.

15. The system for displaying data of claim 9, wherein the first display area and the second display area are both controlled by a single scroll bar.

16. The system for displaying data of claim 9, further comprising:
means for handling an event associated with the first display area such that the event synchronously affects the second display area.

17. A computer program product for displaying data using a display area having a width boundary comprising code for causing a processor to perform the steps of:
determining that data for a list item cannot be displayed within the width boundary;
creating a first display area and a second display area based on the determination that data for a list item cannot be displayed within the width boundary;
splitting the data for the list item into a first portion and a second portion, such that the first portion will fit into the first display area;
displaying the first portion of the data for the list item in the first display area; and
displaying the second portion of the data for the list item wrapped into the second display area.

18. The computer program product for displaying data of claim 17, wherein the first display area is one of a group comprising: a first window and a first pane; and
wherein the second display area is one of a group comprising: a second window and a second pane.

19. The computer program product for displaying data of claim 17, wherein the data for a list item comes from more than one data source.

20. The computer program product for displaying data of claim 17, wherein displaying the second portion of the data further comprises:
displaying at least one column of data from the first portion in the second display area.

21. The computer program product for displaying data of claim 17, wherein displaying the second portion of the data further comprises:
displaying an aid to comprehend whether a row of data in the second display area corresponds to a row of data in the first display area.

22. The computer program product for displaying data of claim 17, wherein the first display area and the second display area are both controlled by a single scroll bar.

23. The computer program product for displaying data of claim 17, further comprising code for causing a processor to perform the step of:
handling an event associated with the first display area such that the event synchronously affects the second display area.

24. A method for displaying data on a display screen comprising:
creating a first display area and a second display area if the data for a list item cannot be displayed within a width of a single display area;
displaying a first portion of the data for the list item on a line in the first display area; and
displaying a second portion of the data for the list item wrapped onto a corresponding line in the second display area.

25. The method for displaying data of claim 24, wherein the first display area is created as one of a group comprising: a first window and a first pane; and
the second display area is created as one of a group comprising: a second window and a second pane.

26. The method for displaying data of claim 24, wherein the first display area and the second display area are created as separate display areas having approximately equal dimensions.

27. The method for displaying data of claim 24, wherein the data for the list item comes from more than one data source.

28. The method for displaying data of claim 24, wherein displaying the second portion of the data further comprises:
displaying at least one datum from the first portion on the corresponding line in the second display area.

29. The method for displaying data of claim 24, wherein displaying the second portion of the data further comprises:
displaying an aid to comprehend that the line in the first display area wraps to the corresponding line in the second display area.

30. The method for displaying data of claim 29, wherein the aid is one of a group comprising: a number and a color.

31. The method for displaying data of claim 24, wherein the first display area and the second display area are both controlled by a single scroll bar.

32. The method for displaying data of claim 24, wherein the first display area and the second display area are both controlled by a single control.

33. The method for displaying data of claim 24, further comprising:
handling an event associated with the first display area such that the event synchronously affects the second display area.
